(19) United States
(12) Patent Application Publication
(10) Pub. No.: US 2002/0040425 A1
(43) Pub. Date: Apr. 4, 2002

(54) Multi-dimensional integrated circuit connection network using LDT

(76) Inventors: David Chaiken, Menlo Park, CA (US); Mark J. Foster, Palo Alto, CA (US)

Correspondence Address: GLENN PATENT GROUP, 3475 EDISON WAY, SUITE L, MENLO PARK, CA, 94025, US

(21) Appl. No.: 09/909,774

(22) Filed: Jul. 19, 2001

Related U.S. Application Data
(63) Continuation-in-part of application No. 09/679,115, filed on Oct. 4, 2000.

(51) Int. Cl. G06F 15/00

(52) U.S. Cl. 712/11

(57) ABSTRACT

The presently preferred embodiment of the invention provides a system in which a plurality of integrated circuits are connected in a multi-dimensional network configuration without requiring an LDT switch. In this configuration, each integrated circuit has more than two LDT Interfaces. For example, integrated circuits with four LDT interfaces are assembled into a two-dimensional mesh. Integrated circuits with four LDT interfaces can also be linked into a PLEX topology.

### BACKGROUND OF THE INVENTION

1. Technical Field

The invention relates to computer networks. More particularly, the invention relates to a multi-dimensional integrated circuit connection network that uses an LDT interface.

2. Description of the Prior Art

LDT (Lightning Data Transport, also known as HyperTransport) is a point-to-point link for integrated circuits (see, for example, http://www.amd.com/news/prodpr/21042.html). Note: HyperTransport is a trademark of Advanced Micro Devices, Inc. of Santa Clara, Calif.

HyperTransport provides a universal connection that is designed to reduce the number of buses within the system, provide a high-performance link for embedded applications, and enable highly scalable multiprocessing systems. It was developed to enable the chips inside of PCs, networking, and communications devices to communicate with each other up to 24 times faster than with preexisting standard bus technologies.

Compared with existing system interconnects that provide bandwidth up to 266MB/sec, HyperTransport technology's bandwidth of 6.4GB/sec represents better than a 20-fold increase in data throughput. HyperTransport provides an extremely fast connection that complements externally visible bus standards such as the Peripheral Component Interconnect (PCI), as well as emerging technologies such as InfiniBand. HyperTransport is the connection that is designed to provide the bandwidth that the InfiniBand standard requires to communicate with memory and system components inside of next-generation servers and devices that power the backbone infrastructure of the telecomm industry. HyperTransport technology is targeted primarily at the information technology and telecomm industries, but any application in which high speed, low latency and scalability is necessary can potentially take advantage of HyperTransport technology.

HyperTransport technology also has a daisy-chainable feature, giving the opportunity to connect multiple HyperTransport input/output bridges to a single channel. HyperTransport technology is designed to support up to 32 devices per channel and can mix and match components with different bus widths and speeds.

The Agile engine manufactured by AgileTV of Menlo Park, Calif. (see, also, T. Calderone, M. Foster, System, Method, and Node of a Multi-Dimensional Plex Communication Network and Node Thereof, U.S. patent application Ser. No. 09/679,115 (Oct. 4, 2000)) uses the LDT technology in a simple configuration, where an interface/controller chip implements a single LDT connection, and the Agile engine connects one other interface/controller chip (such as the BCM12500 manufactured by Broadcom of Irvine, Calif.) on each node board using LDT. Documented designs also deploy LDT in daisy-chained configurations and switched configurations.

In a daisy-chained configuration (see FIG. 1), integrated circuits 10a and 10d communicate over LDT with the cooperation of intermediate integrated circuits 10b and 10c. Each of the intermediate integrated circuits must have two LDT interfaces, and are linked in a one-dimensional, i.e. linear, configuration.

In a switched configuration (see FIG. 2), a special-purpose integrated circuit 21, i.e. an LDT switch, is used to connect multiple integrated circuits 20-20c. Except for the LDT switch, each of the integrated circuits in a switched configuration needs only a single LDT interface.

It would be desirable to provide a system in which a plurality of integrated circuits may be connected using an LDT interface in a multi-dimensional network configuration without requiring an LDT switch.

### SUMMARY OF THE INVENTION

The presently preferred embodiment of the invention provides a system in which a plurality of integrated circuits are connected using an LDT interface in a multi-dimensional network configuration without requiring an LDT switch. In this configuration, each integrated circuit has more than two LDT interfaces. For example, integrated circuits having four LDT interfaces are assembled into a two-dimensional mesh. Integrated circuits having four LDT interfaces can also be linked into a PLEX topology (see T. Calderone, M. Foster, System, Method, and Node of a Multi-Dimensional Plex Communication Network and Node Thereof, U.S. patent application Ser. No. 09/679,115 (Oct. 4, 2000)). Those skilled in the art will appreciate that integrated circuits with more than two LDT interfaces may form a variety of multi-dimension topologies in addition to the mesh and the PLEX.

### BRIEF DESCRIPTION OF THE DRAWINGS

FIG. 1 is a block schematic diagram showing a daisy-chained configuration in which a plurality of integrated circuits communicate using an LDT interface with the cooperation of intermediate integrated circuits;

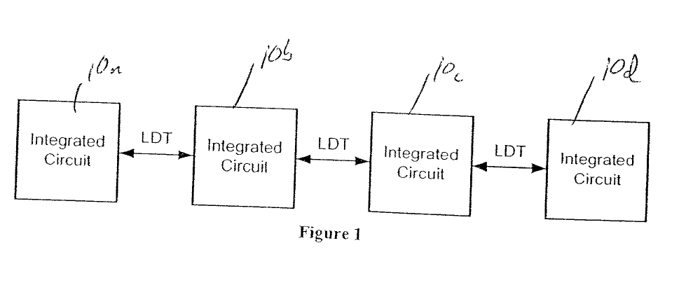

FIG. 2 is a block schematic diagram showing a switched configuration that uses an LDT switch to connect multiple integrated circuits;

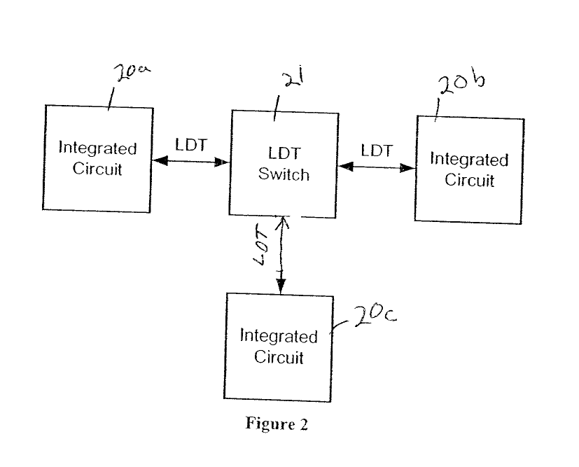

FIG. 3 is a block schematic diagram showing a multidimensional configuration using an LDT interface and that does not require an LDT switch according to the invention; and

FIG. 4 is a block schematic diagram showing a PLEX configuration using an LDT interface and that does not require an LDT switch according to the invention.

### DETAILED DESCRIPTION OF THE INVENTION

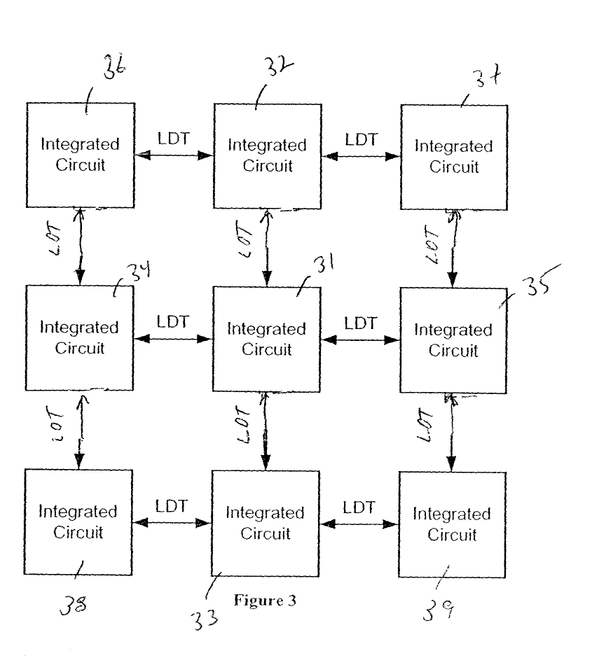

The presently preferred embodiment of the invention (see FIG. 3) provides a system in which a plurality of integrated circuits are connected using and LDT interface in a multi-dimensional network configuration without requiring an LDT switch. In this configuration, at least some of the integrated circuits have more than two LDT Interfaces. For example, integrated circuits having four LDT interfaces are assembled into a two-dimensional mesh. Thus, in FIG. 3 one integrated circuit 31 has four LDT interfaces, four integrated circuits 32-35 have three LDT interfaces, and four integrated circuits 36-39 have two LDT interfaces. While there are different numbers of LDT interfaces shown in the configuration of FIG. 3 with regard to the various integrated circuits, it will be appreciated by those skilled in the art that each of the integrated circuits can have four or more interfaces, where any number of the interfaces, up to the four or more available interfaces, may be used, as required by the architecture in which the integrated circuits are used.

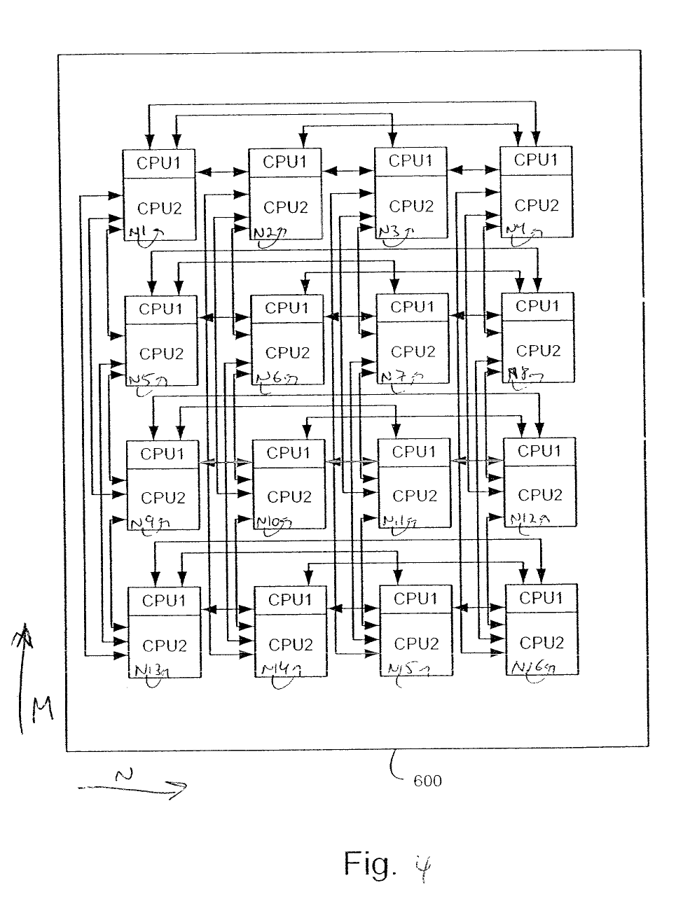

FIG. 4 is a block schematic diagram showing a PLEX configuration using an LDT interface that does not require an LDT switch according to the invention (see T. Calderone, M. Foster, System, Method, and Node of a Multi-Dimensional Plex Communication Network and Node Thereof, U.S. patent application Ser. No. 09/679,115 (Oct. 4, 2000)). For purposes of the discussion herein, PLEX refers to a topology. In FIG. 4, each node N1-N16 has two integrated circuits CPU1, CPU2, each of which has three LDT interfaces, where each of the integrated circuits has a total of four LDT interfaces, the fourth LDT interface coupling the two CPUs together. FIG. 4 depicts a two-dimensional N×M PLEX communication grid 600 with N=4 nodes, each node containing six ports, and having two communications processors, as described above. Such topology is a typical PLEX topology. Those skilled in the art will appreciate that the invention herein is readily applicable to other topologies, including both other PLEX topologies and non-PLEX topologies.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A method for interconnecting elements of a network using an LDT interface in a defined network topology, comprising the steps of:
interconnecting a plurality of integrated circuits in a multi-dimensional network configuration using an LDT interface;
wherein at least one of said integrated circuits has more than two LDT interfaces; and
wherein said integrated circuits are interconnected without requiring an LDT switch.

2. The method of claim 1, wherein each integrated circuit comprises at least four LDT interfaces.

3. The method of claim 1, further comprising the step of:
assembling integrated circuits having four LDT interfaces into a two-dimensional mesh.

4. The method of claim 1, further comprising the step of:
linking integrated circuits having four LDT interfaces into a PLEX topology.

5. A network comprised of elements using an LDT interface in a defined network topology, comprising:
a plurality of integrated circuits connected in a multi-dimensional network configuration using an LDT interface;
wherein at least one of said integrated circuits has more than two LDT interfaces; and
wherein said integrated circuits are interconnected without requiring an LDT switch.

6. The network of claim 5, wherein each integrated circuit comprises at least four LDT interfaces.

7. The network of claim 5, wherein said integrated circuits each comprise four LDT interfaces.

8. The network of claim 7, wherein said integrated circuits are assembled into a two-dimensional mesh.

9. The network of claim 7, wherein said integrated circuits are linked into a PLEX topology.
